(19) United States
(12) Patent Application Publication
(10) Pub. No.: US 2026/0243612 A1
(43) Pub. Date: Aug. 20, 2026

(54) SYSTEM AND METHOD OF THERMAL CHARACTERIZATION OF A PHYSICAL OBJECT

(71) Applicant: ANSYS, INC., CANONSBURG, PA (US)

(72) Inventors: Myunghoon Lee, Namyangju-si (KR); Subodh Deodhar, Pune (IN); Vamsi Krishna Yaddanapudi, Hyderabad (IN)

(21) Appl. No.: 19/218,128

(22) Filed: May 23, 2025

(30) Foreign Application Priority Data
Feb. 15, 2025 (IN) 202541013128

(51) Int. Cl. G01K 17/20; G01N 25/18

(52) U.S. Cl. CPC G01K 17/20; G01N 25/18

(57) ABSTRACT

A system and method of thermal characterization of a physical object includes receiving, by a memory of the system, several heat transfer coefficients (HTCs) respectively associated with several temperatures corresponding to a surface of a physical object, and several thermal resistance (R) matrices associated with respective HTCs of the several HTCs. The method includes determining, by a processing device of the system, an R matrix associated with a current temperature of the surface based on an interpolation of the several R matrices. The method includes performing, by the processing device, thermal evaluation for the physical object based on the R matrix to obtain an updated temperature of the surface. The method includes determining, in response to a convergence criteria being met, a temperature distribution at the surface of the physical object based on the R matrix.

The present application claims priority to and the benefit of Indian Patent Application number 202541013128, filed on Feb. 15, 2025, the disclosure of which is hereby incorporated by reference in its entirety.

### BACKGROUND

### Field

The present disclosure relates to methods and systems of modeling physical objects. More specifically, the present disclosure relates to methods and systems of performing thermal characterization of physical objects that dissipate heat.

### Background Information

Mobile device processors continue to evolve toward stacked architectures, which enhance performance but have greater heat dissipation. For example, the adoption of 2.5D and 3D stacked architectures, along with heterogeneous integration technologies, has led to an increase in power density per unit area. As process scaling reaches its limitations, chiplet-based designs are emerging as a viable alternative. However, these advancements introduce several technical challenges. Advanced application processors (APs) incorporating multiple functional dies experience higher heat dissipation per unit area, posing significant thermal management concerns. Conventional Computational Fluid Dynamics (CFD)-based thermal evaluation methods are not only time-consuming but also demand substantial computational resources. Additionally, existing thermal resistance matrix models are constrained by fixed thermal boundary conditions, reducing their accuracy in dynamic operating environments. Addressing these challenges is crucial for optimizing thermal performance in next-generation semiconductor designs.

Modern SoC (System-on-Chip) in mobile device APs have a requirement for continuous improved performance and efficiency through process scaling. However, as the limitations of process shrinkage become increasingly apparent, chiplets have emerged as a practical solution to address these challenges. This shift has driven SoC designs from traditional planar architectures to three-dimensional stacked structures. While this transition enables enhanced performance, it also introduces significant challenges for designers, who must consider power integrity, signal integrity, thermal characteristics, and reliability in an integrated manner to achieve effective performance.

In particular, the adoption of 3D-stacked architecture has led to a substantial increase in power density per unit area, resulting in greater heat dissipation. This necessitates proactive thermal management, as it becomes a critical factor that directly limits the performance of mobile APs. Proper thermal management is not only essential for maintaining system stability but also for ensuring long-term reliability.

This structural shift underscores the growing importance of considering thermal characteristics during the early stages of SoC design, particularly in a floor plan design phase. During the initial floor planning phase, strategically placing individual power sources and thermal sensors is crucial for effective thermal management. To address this, thermal characterization models based on thermal resistance matrices have gained significant attention. These models leverage the principle of linear superposition to quantitatively analyze self-heating effects and thermal coupling effects within a chip, enabling more efficient thermal assessments compared to traditional CFD based workflows during early design stages.

### SUMMARY

Existing thermal resistance matrix models operate under fixed thermal boundary conditions, limiting their accuracy in accounting for the dynamic conditions encountered in various operating scenarios and environments. Modern advanced application processors (APs) operate in complex systems characterized by diverse operating frequencies, thermal sensor feedback-based control, and fluctuating thermal environments. This complexity necessitates an extended thermal characterization model capable of accommodating such dynamic conditions. To overcome the limitations of existing models, a novel thermal performance evaluation process based on a linear parameter-varying (LPV) thermal resistance matrix is disclosed. The proposed process integrates thermal boundary conditions, particularly heat transfer coefficients (HTCs), extracted from computational fluid dynamics (CFD) models under various conditions. By calculating HTC values based on temperature monitoring in specific areas and generating dynamic thermal resistance matrices, this approach expands the applicability of the model to various operating scenarios and thermal environments.

A method and system of thermal characterization of a physical object, such as a mobile device AP, is provided below. In an embodiment, the system has a memory and a processing device to execute instructions stored on a non-transitory computer-readable medium to cause the system to perform the method. The method includes receiving, by the memory of the system, several HTCs respectively associated with several temperatures corresponding to a surface of a physical object, and several thermal resistance (R) matrices associated with respective HTCs of the several HTCs. The method includes determining, by the processing device of the system, an R matrix associated with a current temperature of the surface based on an interpolation of the several R matrices. The current temperature is based on a power distribution applied to several power sources of the physical object. The method includes performing, by the processing device of the system, thermal evaluation for the physical object based on the R matrix to obtain an updated temperature of the surface. The method includes determining, in response to a convergence criteria being met, a temperature distribution at the surface of the physical object based on the R matrix.

The above summary does not include an exhaustive list of all aspects of the present invention. It is contemplated that the invention includes all devices, systems, and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is a perspective view of a physical object, in accordance with an embodiment.

FIG. 2 is a sectional view of a physical object, in accordance with an embodiment.

FIG. 3 is a flowchart of a method of generating a design of a physical object, in accordance with an embodiment.

FIG. 4 is a flowchart of a method of performing thermal characterization of a physical object, in accordance with an embodiment.

FIG. 5 is a table of heat transfer coefficients respectively associated with temperatures corresponding to a surface of a physical object, in accordance with an embodiment.

FIG. 6 is a flowchart of a method of extracting thermal resistance matrices for various heat transfer coefficient conditions, in accordance with an embodiment.

FIG. 7 is a pictorial view of power values applied to several power sources of a physical object, in accordance with an embodiment.

FIG. 8 is a representation of several thermal resistance matrices associated with respective heat transfer coefficients, in accordance with an embodiment.

FIG. 9 is a flowchart of a method of determining a temperature distribution at a surface of a physical object, in accordance with an embodiment.

FIG. 10 is a schematic view of a physical object having several power sources, in accordance with an embodiment.

FIG. 11 is a pictorial view of a temperature distribution of a surface of a physical object, in accordance with an embodiment.

FIG. 12 is a schematic view of a physical object having several power sources, in accordance with an embodiment.

FIG. 13 is a pictorial view of a temperature distribution of a surface of a physical object, in accordance with an embodiment.

FIGS. 14-16 depict systems that may be used in conjunction with the embodiments described herein.

### DETAILED DESCRIPTION

Embodiments describe a system and method of thermal characterization of a physical object. The system and method can be embodied as software running on a server-oriented system or a standalone computer.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

The use of relative terms throughout the description may denote a relative position or direction. For example, “above,” “forward,” etc. may indicate a first direction in a referential space. Similarly, “below,” “backward,” etc. may indicate a second direction in an opposite direction from the direction. Such terms are provided to establish relative frames of reference, however, and are not intended to limit the methods or systems to a specific configuration described in the various embodiments below.

In an aspect, a system and method performs thermal characterization of a physical object. The system can store several R matrices, each associated with a respective HTC, and receive temperature data corresponding to a designated surface of the physical object. A processing device is configured to determine a current temperature distribution on the surface based on a power map applied to multiple power sources, interpolate an HTC value based on the current temperature of the surface, and then interpolate an R matrix corresponding to the interpolated HTC. A surface temperature or a temperature of a surface can refer to a representative value of the temperature distribution over the surface, such as an average value, median value, or other applicable statistical or characteristic measures. The system iteratively performs thermal evaluations using the interpolated HTC and R matrix values to update the temperature field, repeating the process until a convergence criterion is satisfied. This approach leverages pre-generated R matrices for representative HTC values and dynamically adapts the thermal resistance model to changing boundary conditions by interpolating between these matrices as a function of surface temperature. Accordingly, the invention enables fast and accurate thermal performance evaluation across diverse and dynamic operating scenarios, significantly reducing computational time and improving the fidelity of temperature predictions in advanced multi-die package designs. More particularly, the disclosed mechanism can be used in thermal-aware floor plan design optimization of a heterogeneous multi-die package of a mobile device application processor (AP). The method may, however, be used in thermal characterization of other physical objects and, accordingly, reference to multi-die packages below are intended to be illustrative and not limiting.

Additional summary is provided here to fully prepare the reader ahead of the detailed description below. This summary is intended to reinforce, rather than repeat, the description above. The following description provides a mechanism to model dynamic thermal characteristics of a multi-die package where thermal boundary conditions are dependent on specific surface temperatures. By establishing a relationship between HTCs and surface temperature, the R matrix can be dynamically interpolated. Rapid interpolation allows for the rapid generation of R matrices based on different input total power levels applied to the dies of the multi-die package. The interpolated model leverages pre-generated thermal resistance matrices extracted under specific HTC conditions, enabling the application of surface temperature-dependent thermal resistance models for accurate and efficient thermal evaluations across diverse scenarios.

In one embodiment, the thermal characteristics of a complex heterogeneous multifunctional die can be represented using a R matrix model. For example, in CFD simulations, the R matrix is typically extracted by performing thermal-fluid analysis based on the power input to the die. After this analysis, the boundaries of the system are modeled in terms of convective heat transfer, and a fixed convective HTC is extracted. The fixed convective HTC is then substituted as a parameter in the described mechanism to model dynamic thermal characteristics of a multi-die package. For instance, in the case of a cubic system boundary, there may be six surfaces, and the HTC for each surface is individually determined. These coefficients are then represented as a single parameter by considering the proportional relationship among the surfaces. When a representative HTC is defined for one surface, the HTC values for the other surfaces can be naturally applied in proportion. The disclosed mechanism leverages the thermal resistance matrix representation under a single fixed convective HTC as a thermal boundary condition to capture the thermal behavior of a system-on-chip (SoC) package across various operational scenarios.

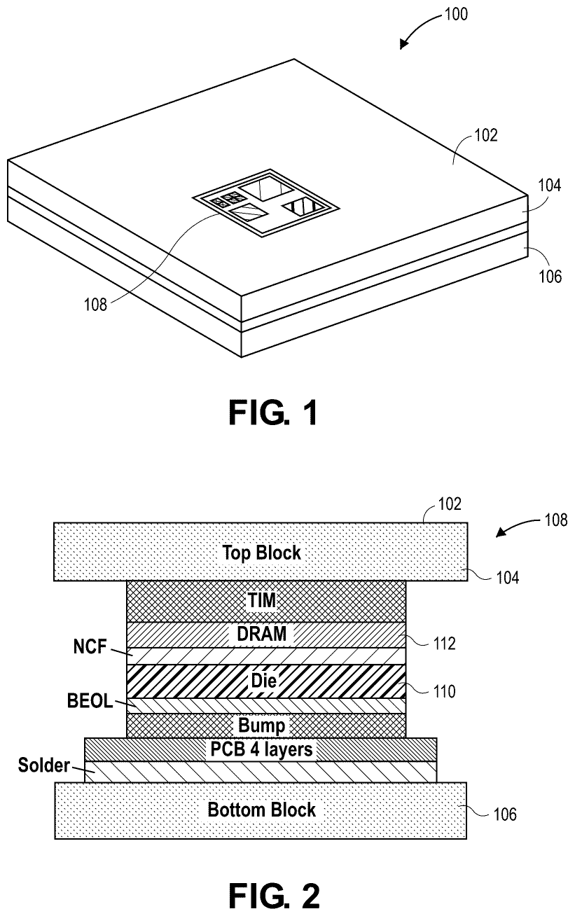

Referring to FIG. 1, a perspective view of a physical object is shown in accordance with an embodiment. A computer-implemented method performed by a system, as described below, can perform a thermal performance evaluation using linear parameter varying (LPV) based R matrix modeling of a physical object 100. The physical object 100 may, for example, include a chiplet, or several chiplets, combined to form an SoC for a mobile electronic device, such as a tablet or a smartphone. The chiplets may be placed side-by-side in a 2.5D architecture or stacked in a 3D architecture. Such heterogeneous integration technologies can increase power density of the chiplet-based designs. More particularly, when the SoC includes multiple functional dies, heat dissipation per unit area can increase. The methodology described below, for thermal performance evaluation using LPV-based R matrix modeling can advantageously optimize thermal aware floor plan design of the heterogeneous multi-die package, as compared to traditional CFD-based thermal evaluation methods that are time- and resource-intensive.

The physical object 100 can include a surface 102, e.g., a top surface 102 exposed to a surrounding environment, at which temperature 506 distribution may be evaluated. More particularly, the system described below can perform thermal evaluation of the physical object 100 to determine the temperature 506 distribution at the surface 102 of the physical object 100. Notably, whereas existing R matrix models operate under fixed thermal boundary conditions (boundary conditions at the surface 102), which can limit accuracy in dynamic operating scenarios applicable to high power density of SoC designs, the methodology described below can account for various and dynamic thermal conditions at the surface 102, leading to fast and accurate thermal performance evaluation of the physical object 100.

The physical object 100 can include a top block 104, which may represent a boundary of the system. For example, the top block 104 can be an outer housing of a mobile device. More particularly, the top block 104 can be an upper panel such as a display panel of the mobile device, vertically above a bottom block 106, which can be a lower panel or backplate, of a mobile device. The top and bottom blocks 106 can contain, e.g., sandwich, an AP package 108 of the mobile device. The AP package 108 can include several layers, as described below, which perform data processing for the mobile device.

Referring to FIG. 2, a sectional view of a physical object is shown in accordance with an embodiment. The AP package 108 can, rather than being a traditional planar structure, include a three-dimensional stacked architecture. More particularly, the AP package 108 can be a highly integrated semiconductor device, such as an SoC, that includes one or more semiconductor dies. For example, the AP package 108 can include one or more dies, such as a processing die 110 including an integrated circuit constituting a processing unit, or a memory die 112 including an integrated circuit constituting dynamic random access memory (DRAM). The layers may include additional components of the AP package 108, such as thermal interface material, solder, etc., which form the heterogeneous multi-die package. In an embodiment, the layers of the AP package 108 are in physical contact and therefore transfer heat conductively. By contrast, a surface 102 of the top block 104 may be exposed to the surrounding environment and can transfer heat thereto via convective heat transfer.

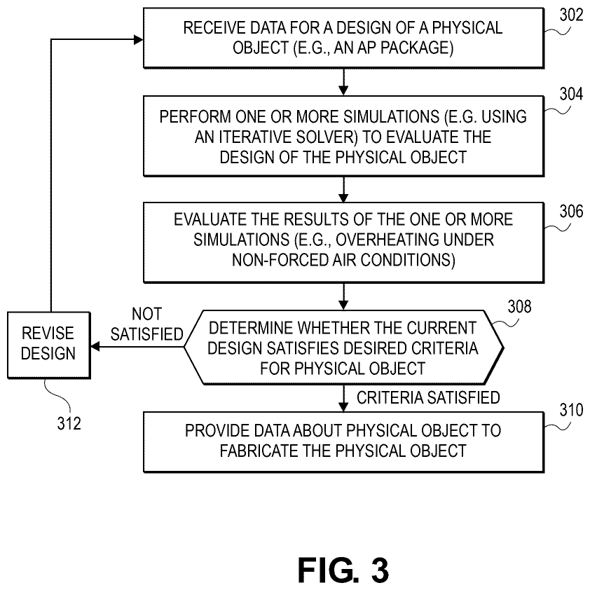

Referring to FIG. 3, a flowchart of a method of generating a design of a physical object is shown in accordance with an embodiment. The method can be used to design the physical object 100 to meet predetermined performance criteria. More particularly, the embodiments described herein can be used in simulations of the physical object 100 in order to determine whether a particular design of the physical object 100 satisfies particular design requirements. For example, simulations of various floor plan designs of the physical object 100 can be performed to determine an optimal floor plan design under various operational scenarios. FIG. 3 shows a method in which the design requirements can be tested relative to a particular design of the physical object 100 that is being simulated.

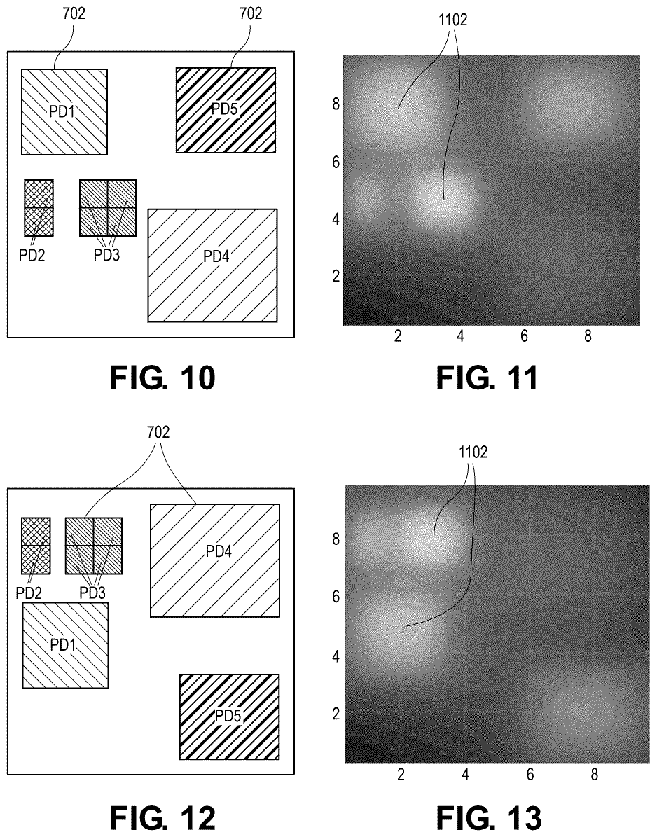

At operation 302 of FIG. 3, a data processing system (e.g., a computer executing simulation software to provide a simulation system) can receive data about a design for a particular physical object 100, e.g., the AP package 108 and/or portion of the mobile device, shown in FIGS. 1 and 2. The data can be created in computer-aided design (CAD) software on a data processing system, and the data can include a floor plan design of the physical object 100, such as the floor plan designs shown in FIGS. 10 and 12, below.

At operation 304, the data processing system can perform one or more simulations (such as simulations based on convective heat transfer of the physical object 100 to the surrounding environment under various operating conditions) to evaluate the design of the physical object 100. The evaluation can include determining, for example, performance data (such as thermal performance) during the simulated operation of the physical object 100.

At operation 306, the designer can evaluate the results of the one or more simulations to determine whether the design of the physical object 100 satisfies certain desired criteria for the design. For example, whether the physical object 100 remains sufficiently cool without forced air cooling during device operation. This determination is shown at operation 308. If the one or more criteria is satisfied, then the designer at operation 310 can provide data about the physical object 100, e.g., the floor plan, to allow the fabrication or manufacture of the physical object 100. For example, if the one or more criteria are satisfied, a CAD file can be produced that describes how to build the physical object 100. If the criteria are not satisfied as determined in operation 308, the designer can revise the design in operation 312 (for example, by changing a layout of the integrated circuit(s) in the AP package 108, a material, etc. of the physical object 100) and repeat the process by performing additional further simulations to evaluate the redesigned physical object 100. This can be repeated until the desired criteria are achieved for the physical object 100.

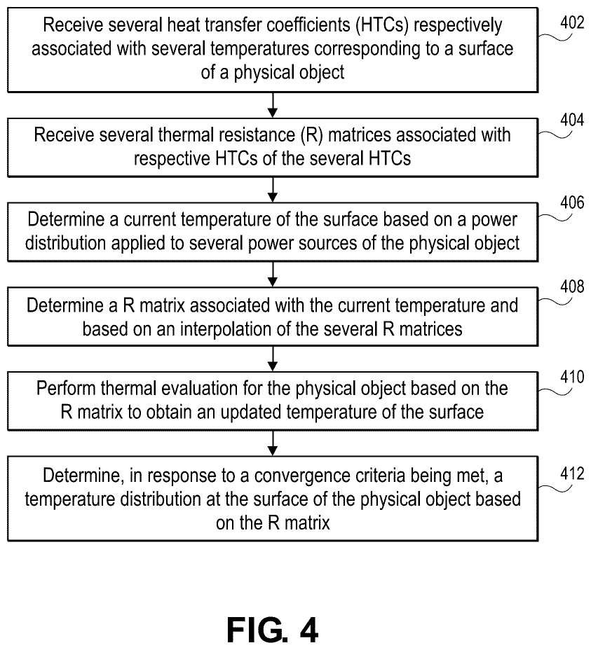

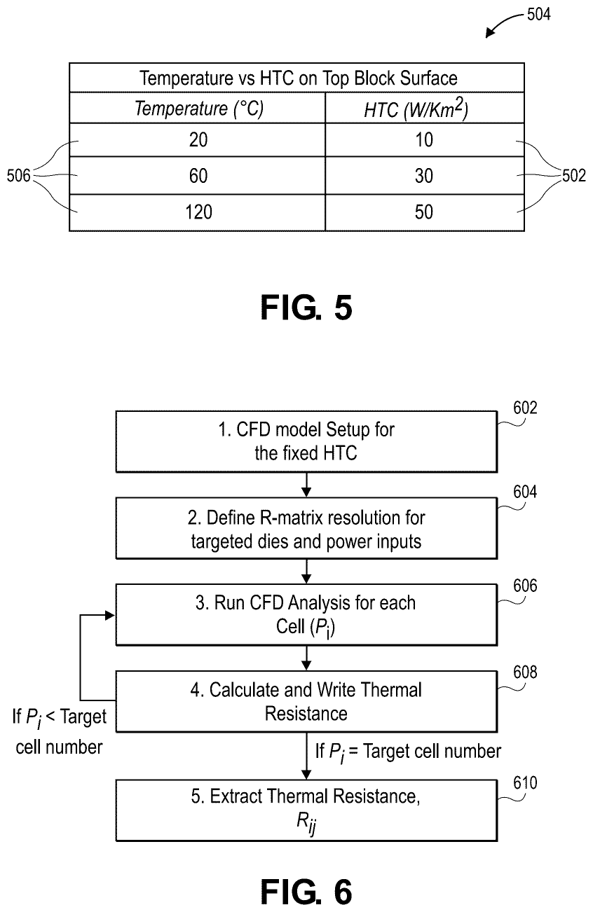

Referring to FIG. 4, a flowchart of a method of performing thermal characterization of a physical object is shown in accordance with an embodiment. Whereas FIG. 3 shows a method of analyzing design performance, FIG. 4 provides a method for performing thermal evaluation of the physical object 100. More particularly, the method can be used to predict temperature contour on the surface 102 to generate the floor plan of the physical object 100. The method includes operations that are illustrated in FIGS. 5-13, and thus, FIGS. 5-13 shall be referred to and described in combination below. An input of the method can be a geometry of the physical object 100, including predefined circuits in the physical object 100, e.g., “IP blocks,” that perform a specific function in a SoC system. The output of the method can be the floor plan of the physical object 100 for use in the design method of FIG. 3.

Modern AP packages 108 operate in diverse thermal environments, where operating frequency and boundary conditions are controlled based on temperatures measured by thermal sensors under various operational scenarios. Therefore, there is a need to extend thermal characterization modeling using R matrices to accommodate these varied convective heat transfer conditions.

A thermal performance evaluation process, as described below, can be based on linear parameter varying (LPV) R matrices. The process can incorporate convective HTCs as thermal boundary conditions applied in CFD models. In an embodiment, at operation 402, a memory of a system can receive several HTCs respectively associated with several temperatures corresponding to the surface 102 of the physical object 100.

Referring to FIG. 5, a table of heat transfer coefficients respectively associated with temperatures corresponding to a surface of a physical object is shown in accordance with an embodiment. The several HTCs 502 respectively associated with several temperatures 506 may be in the form of data in a lookup table 504. For example, an HTC lookup table 504 can include HTC values 502 corresponding to respective surface temperatures 506 of the surface 102 of the physical object 100. More particularly, the HTC values 502 may correspond to an average HTC value across the surface 102 corresponding to an average surface temperature 506 across the surface 102.

The average surface temperature 506 and average HTC 502 may be prepared by CFD analysis based on several assumptions. The CFD analysis can be performed using a system geometry and heat source locations are fixed. Heat source locations can include IP blocks or other power sources, e.g., in the processing die 110 or the memory die 112, which generate heat when power is applied to them. Accordingly, the heat sources can generate heat that causes a rise in temperature 506 at the surface 102 of the physical object 100.

When power is applied to heat sources, heat can distribute to each of six surfaces of the system geometry. More particularly, the CFD analysis can be performed on a portion of the SoC system, such as the AP package 108 shown in FIG. 2, that has the top surface 102, the bottom surface, and four sides extending vertically between the top surface 102 and the bottom surface. The heat can distribute to the six surfaces in a consistent and predictable ratio. The AP package 108 can represent the equivalent CFD modeling of a smartphone, and the thermal boundary conditions may be defined by the top and bottom glass surfaces. Notably, the actual HTC values 502 may differ between these surfaces. To standardize HTC 502 as a single parameter, an assumption is made. More particularly, when power is applied to the AP chip die, a CFD simulation under natural convection conditions is conducted to extract the HTC values for both the top and bottom glass surfaces. The top block surface 102 and the bottom block surface HTC values can be coupled. More particularly, the ratio between these HTC values can be computed and assumed to remain constant, irrespective of variations in power dissipation of the chip. The different surface temperature distributions on the six surfaces 102 of the modeled package structure can lead to different average HTC values on each face, but the surfaces can be modeled as a function of a single parameter: the HTC 502 of the top surface 102 (facing upward, +z, opposite gravity) is selected as the reference surface. By adopting this assumption, HTC 502 can be parameterized as a single variable, simplifying the thermal modeling process while maintaining accuracy across different power dissipation scenarios. In the table of FIG. 5, and in the following description, the HTC 502 of the surface 102 of the top block 104 is chosen as the primary parameter, while the HTC of the bottom surface of the bottom block 106 can be automatically determined as a function of the top surface HTC. More particularly, HTCs on all other faces (−z, +x, −x, +y, and −y surfaces) are defined as fixed ratios relative to the HTC 502 of the reference face. Accordingly, the HTC 502 of the surface 102, which varies with average temperature 506 of the surface 102 can be computed and stored in the HTC lookup table 504.

At operation 404, the memory of the system can receive several R matrices associated with respective HTCs of the several HTCs 502 received at operation 402. R matrices can include matrix elements that represent thermal resistance of locations in the system, e.g., at a level of a die or other power source. The thermal resistances account for both conductive and convective heat transfer at those locations. The R matrices can be extracted in a process that uses a complete CFD thermal model for various HTC 502 conditions. R matrix modeling can be used for representing thermal characteristics of highly integrated semiconductor devices, such as SoCs, in a mathematical matrix form. The R matrix models, such as those shown in FIG. 8 below, can be based on the principle of linear superposition, enabling quantitative analysis of self-heating and thermal coupling effects among IP blocks. More particularly, each element Rᵢⱼ in the R matrix represents the influence of the power generated by IP block j on the temperature rise of IP block i. Accordingly, if the thermal resistance matrix R has M×N tiles, the relationship between a power vector, P, and the resulting temperature 506 vector, T, can be expressed as follows:

$$Ti = {\sum }_{j = 1}^{N} Rij * Pj for i = 1 , 2 , … , M ,$$

Tᵢ: Temperature of the location i.
Rᵢⱼ: Thermal resistance matrix. i is the location of temperature monitoring and j is the location of power source.
Pⱼ: Power of the location j.
M: Total number of power sources.
N: Total number of temperature monitoring points.

Referring to FIG. 6, a flowchart of a method of extracting thermal resistance matrices for various heat transfer coefficient conditions is shown in accordance with an embodiment. At operation 602, a CFD model is set up for a fixed HTC. The HTC of the system changes because as the temperature increases at the outer surfaces of the system, so does the HTC increase, when dealing with a non-forced air problem. Accordingly, the HTC can be fixed at a value that a set of R matrices is being developed for.

To extract Rᵢⱼ from the system at the fixed HTC(s) that are being evaluated, a complete CFD thermal model is required. The model can include a 3D layout of the package structure as well as the location and size of IP blocks in an SoC design. The CFD model can include the AP package 108 of FIG. 2. The CFD model can be fully calibrated using test-measured data, enabling the full smartphone model to be simplified into three blocks: the top block 104, the bottom block 106, and a PCB block, which can include the several dies, e.g., the processing die 110 and/or the memory die 112, between the top and bottom blocks.

At operation 604, an R matrix resolution can be defined for targeted dies and power inputs. By employing equivalent thermal modeling for the three blocks of the CFD model, a number of CFD volume mesh elements can be reduced. It will be appreciated that such simplification can be useful for quick thermal evaluations of new floor plan designs and parametric studies exploring the design space of the AP package 108.

In an embodiment, the targeted dies and power inputs include, for example, the processing die 110 or the memory die 112. Operation 604 establishes the foundational data structure that enables rapid and accurate construction of a thermal resistance matrix (R matrix) for each of these dies of interest. A user can select the one or more targeted dies (e.g., the processing die 110 or the memory die 112) and specify a two-dimensional grid resolution, which may be expressed as a tiling scheme that includes a predetermined number of cells for each power source of the die, across the active surface 102 of each selected die. For example, the die can have N sources represented by 1 object, and the N sources may be represented by 4*N mesh elements (also known as cells). More particularly, each cell can represent a unit block of a chip die area. A grouping of the cells representing a power source can be referred to as a tile. In the case of 1 object representing a die having 4 sources, the tiling scheme can include 16 cells representing the 4 sources. This is a simplification, as modern SoCs can have thousands of power sources (or tiles) per die. Each tile will later correspond to a discrete power source (or “source cell”) in the R matrix, and the aggregate of all tiles defines the spatial granularity with which local self-heating and inter-die coupling effects can be captured.

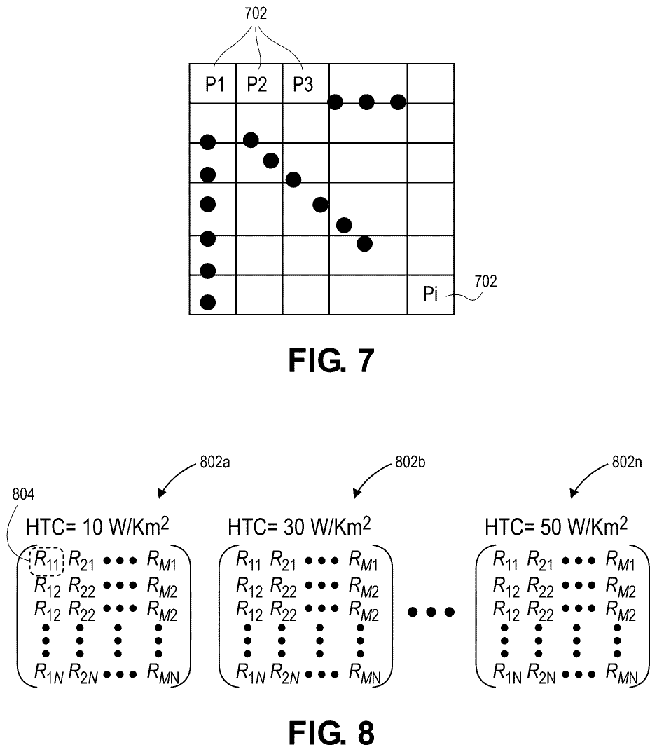

Referring to FIG. 7, a pictorial view of power values applied to several power sources of a physical object is shown in accordance with an embodiment. Starting from the CFD model a user can select several dies and define their resolution, along with power inputs for each unit tile. The unit tiles of the AP package 108, several of which are labeled P1, P2, P3, and Pi in the figure, and the power applied to each of the tiles, can be defined.

The geometric tiles and the power inputs can be used to solve for temperature rises that result from the power distribution. More particularly, at operation 606, CFD analysis can be run for each of the cells (unit tiles) in the tiling scheme of the AP package 108. The user can designate a representative power input value, or a power-map file, which identifies the total electrical power expected to be dissipated by each tile during subsequent R matrix extraction. The CFD simulations can be automatically executed to measure a thermal resistance for each tile on the selected dies.

At operation 608, the thermal resistance can be calculated and written for a unit tile, such as the tile defined as P1. The process of running CFD analysis and computing thermal resistance can be repeated for each unit tile, e.g., P2, P3, . . . . Pi, of the AP package 108. More particularly, the process can continue until all M×N tiles of the target dies are swept, and their thermal resistance values are measured.

At operation 610, the thermal resistance matrix, Rᵢⱼ, can be extracted. Thermal resistance values for all M×N unit blocks on a die, e.g., between the die and a back end of line (BEOL), can be extracted. The single object within the CFD or finite-volume solver environment virtually embodies all N sources of the target die. Rather than treating every tile as an independent geometric component—an approach that would inflate mesh size, solver iterations, and file-handling overhead—the consolidated object acts as a parent container whose underlying mesh elements can be programmatically activated, de-activated, and power-weighted on a per-tile basis during an automated sweep. The object can therefore serve as both a spatial mask and a power-distribution template, allowing a solver to iterate through the N tiles, inject the prescribed power for each tile, and record resulting temperature responses at all other tiles without rebuilding or re-exporting the model between runs. By embedding the N-source representation inside a single object at the definition stage (operation 604) simulation turnaround time can be drastically reduced. CFD can be iteratively run to calculate and write thermal resistance for each of the target cell numbers, P1 to Pi, from several days (using traditional source-by-source workflows to evaluate 2500 sources) to mere hours (using the approach described above to evaluate 2500 sources). The above approach can, in addition to the substantial time savings, preserve the fidelity required to populate the full M×N R matrix for subsequent linear-superposition evaluations and LPV-based interpolations.

Referring to FIG. 8, a representation of several thermal resistance matrices associated with respective heat transfer coefficients is shown in accordance with an embodiment. Modern innovative 2.5D and 3D SoC designs, particularly, those used in mobile devices and high-performance computing, operate under varying thermal conditions influenced by factors such as power dissipation, operating frequency, cooling mechanisms (natural or forced), and environmental variations. Although the approach described above simplifies the thermal evaluation process, reducing the time required for thermal evaluation by days, the variation in system performance under varying thermal conditions still prohibits the above approach from reflecting real-world systems operating in dynamic thermal environments having an HTC value that differs from the value used to produce the R matrix 802.

An approach to perform rapid evaluation of varying thermal conditions follows, and is based on the interpolation between R matrices. Accordingly, in an embodiment, several R matrices are generated using the above-described approach. Each R matrix 802 is depicted in schematic matrix form. The R matrices are labeled 802a-802n, and are collectively “R matrices” generated in correspondence with a set of discrete, predetermined HTCs used by the disclosed thermal-management system. Each R matrix 802 comprises a two-dimensional array of thermal-resistance values Rᵢⱼ, where the indices i and j extend from 1 to m and 1 to n, respectively, thereby defining a complete resistance network for the m-by-n node lattice upon which the system's conjugate heat-transfer calculations are performed. By way of non-limiting example, a first R matrix 810a is populated with thermal resistance values R11 through Rmn that collectively reflect an HTC 502 of 10 W/K·m², a second R matrix 810b contains a corresponding set of thermal resistance values calibrated to an HTC 502 of 30 W/K·m², and an nth R matrix 810n embodies thermal resistance values tuned to an HTC 502 of 50 W/K·m². By way of example, the thermal resistance value 804 of element R11 represents a relationship between a power source P1 of the physical object 100 and a temperature rise corresponding to a location on the surface 102 of the top block 104 above the power source P1.

The ellipses between R matrix 802b and 802n emphasize that the illustrated matrices represent merely a subset of the full library that may be generated, stored, and selectively retrieved during runtime to accommodate additional HTCs 502. In implementation, each Rᵢⱼ element within a given R matrix 802 may be derived from empirical test data, analytical modeling, or a combination thereof, thereby enabling granular, node-specific accommodation of conduction, convection, and/or radiation effects as may be dictated by the geometry and material properties of the modeled assembly. Consequently, FIG. 8 underscores the modular, scalable nature of the R matrix architecture of the following approach, wherein any number of R matrices can be used to perform thermal simulations across a broad spectrum of boundary conditions without necessitating real-time recalculation of the entire resistance network.

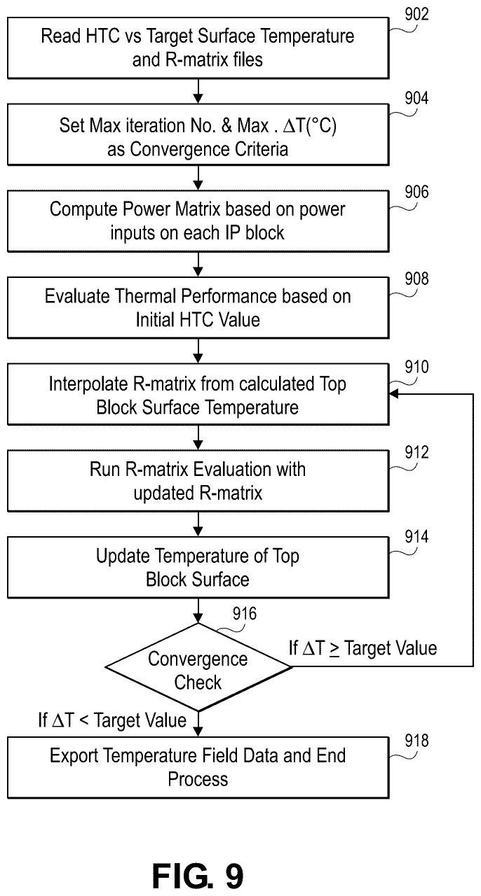

Referring to FIG. 9, a flowchart of a method of determining a temperature distribution at a surface of a physical object is shown in accordance with an embodiment. The thermal characteristics of complex heterogeneous multi-functional dies can be represented using a thermal resistance matrix model. Traditionally, the thermal resistance matrix is extracted under fixed convective heat transfer coefficients, which are typically used as thermal boundary conditions in CFD simulations. However, such an approach is limited in capturing the thermal behavior of an SoC package across various operational scenarios. To address the limitations of existing thermal performance evaluation methods to deal with varying thermal boundary conditions, an LPV-based R matrix modeling is proposed. The approach integrates dynamic variations in HTC based on target surface temperature, and utilizes a pre-defined surface temperature versus HTC table, such as the lookup table 504 shown in FIG. 5, and corresponding pre-extracted R-matrices for various HTC values. More particularly, the modeling method includes thermal boundary conditions that are dependent on specific surface temperatures, and by establishing a relationship between HTC and surface temperature, the thermal resistance matrix can be dynamically interpolated. By interpolating between the R matrices, the LPV R matrix approach enables accurate thermal evaluations that adapts to dynamic conditions encountered during SoC operation. More particularly, the dynamic interpolation allows for rapid generation of thermal resistance matrices based on different input total power levels applied to the dies, and the interpolated model leverages pre-generated thermal resistance matrices extracted under specific HTC conditions, enabling the accurate and efficient thermal evaluations across diverse scenarios. An operation-by-operation process flow is shown in FIG. 9, and described below. The approach integrates the HTC and R matrix interpolation to predict temperature fields across the system.

At operation 902, which corresponds to operations 402 and 404 of FIG. 4, the method initiates by receiving two categories of input data that collectively define the thermal characterization space for the evaluation engine. First, at operation 402, the processing system receives the several HTCs 502 respectively associated with several temperatures 506 corresponding to the surface 102 of the physical object 100, e.g., the lookup table 504 data of FIG. 5. The lookup table 504 maps averaged target-surface temperatures 506 to corresponding average HTC values 502, and was generated from calibrated CFD simulations under natural- or forced-convection boundary conditions, as described above. Second, at operation 404, the processing system receives the R matrices, which are pre-extracted and have been generated off-line for several representative HTC values 502, as described above. Each of the R matrices describes, tile-by-tile, a steady-state temperature rise at monitored die locations produced by unit power applied to corresponding power-source tiles, thereby capturing both self-heating and thermal-coupling effects in a linear superposition framework.

The input datasets can be loaded into memory, and the engine can use the data to establish a baseline from which interpolated HTC and interpolated R matrix values can be derived during subsequent iterations, obviating the need for further CFD runs during the fast evaluation loop. More particularly, the received input datasets serve as key inputs for the evaluation that follows, which allows for thermal performance to be performed instantaneously to evaluate system component placement (heat source placement) without performing CFD simulations.

At operation 904, the method parameterizes an iterative solution loop by defining numerical convergence controls. More particularly, a convergence criteria is defined for the iterative solution loop. The convergence criteria can include a maximum iteration number and/or a maximum temperature difference.

The maximum iteration number can be a counter that caps the number of HTC-update cycles permitted for any single evaluation run. For example, a maximum of 10-15 iterations can be selected within which the natural convection problem can be solved for. By capping the number of iterations, excessive computations can be prevented, e.g., in the case of slowly converging thermal evaluations. Accordingly, the convergence criteria can produce reasonable thermal evaluation estimates within a reasonable amount of time.

The maximum temperature difference can be a predetermined temperature threshold that is permissible to drive continued iterations. For example, the predetermined temperature threshold can be a difference, e.g., 1 degree Celsius, between an updated temperature of the surface 102, calculated during an iteration, and a current temperature of the surface 102, at the beginning of the iteration. The predetermined temperature threshold can be a scalar representing the maximum acceptable difference, between successive iterations, in the averaged temperature of the designated target surface (e.g., a top block surface of the package or enclosure).

The convergence criteria can include one or both of the maximum iteration number or the predetermined temperature threshold. By establishing both a hard iteration limit through the maximum iteration number, and the predetermined temperature threshold, the procedure can ensure numerical stability and deterministic stopping conditions regardless of the initial guess or the thermal severity of the applied power map.

At operation 906, the system translates the user-provided power-dissipation profile into a structured numeric object referred to as a power matrix. The power matrix can align spatially with the discretization used for the R matrix 802 elements. For example, each element of the power matrix can correspond to a specific IP block tile or functional sub-region on the die. The power matrix can represent power values applied to the power sources 702 of the physical object 100. The power matrix can store the actual wattage allocated to the matrix locations under the operating scenario being analyzed. Building the power matrix can involve parsing design-time floor planning data, associating each IP block with its positional indices, and inserting the power value of the block into the corresponding matrix entries. The resulting matrix therefore, based on the power dissipation of each IP block in the given operating scenario, reflects the thermal loading conditions that drives the ensuing temperature calculations.

At operation 908, the procedure selects an initial HTC value to seed the iterative solution loop. In an embodiment, the starting HTC is chosen as the minimum HTC entry in the temperature-to-HTC lookup table 504 (e.g., 10 W/m². K). More particularly, the HTC corresponding to the minimum temperature 506 of the lookup table 504, e.g., 20 degrees Celsius, can be selected so that the first temperature estimate is conservative. Alternative heuristics, however, may use an intermediate or a prior-run HTC 502 to accelerate convergence. The key purpose of this initial selection is to identify the first R matrix that will be applied to the power matrix, thereby producing a first-pass temperature field from which a more representative average surface temperature can be obtained.

At operation 910, the processing device retrieves the pre-extracted R matrix that corresponds exactly to the initial HTC established in operation 908. The pre-extracted R matrix 802 is therefore associated with the current temperature, e.g., 20 degrees Celsius. In subsequent iterations, once a revised HTC has been interpolated, the engine generates an interpolated R matrix by linearly blending the two bounding pre-extracted matrices that straddle the interpolated HTC value. The interpolation process for the HTC 502 and R matrix 802 employs the reciprocal-HTC-weighted formulation described in the equations below.

At operation 912, a complete thermal evaluation is executed by applying the selected or interpolated R matrix to the current power matrix. The R matrix 802 is multiplied by the power matrix-using vector-matrix operations—to yield a preliminary temperature vector for all monitored die tiles. The resulting temperature field provides spatially resolved temperature predictions for each of the targeted logic dies, DRAM, and the top surface area.

At operation 914, the processing device computes a current temperature, which is a new averaged target-surface temperature, directly from the temperature field obtained in operation 912. The operation can correspond to operation 406 of the method shown in FIG. 4. Importantly, the average temperature for the designated target surface-usually the outward-facing top surface 102 area of the package enclosure-serves as the feedback variable for HTC adjustment. The current temperature is based on a power distribution applied to the several power sources 702 of the physical object 100. More particularly, this newly calculated surface temperature 506 is used as the independent variable in the lookup table 504 to interpolate a fresh HTC value via linear interpolation between the two table entries that bound the calculated temperature. The updated HTC thus reflects the coupling between surface temperature and convective boundary condition inherent in natural-convection or temperature-regulated cooling scenarios.

At operation 916, the engine assesses whether the iterative loop has converged. The description will circle back to this determination below, but it may be assumed at this point that the iterative loop does not converge after an initial iteration and, thus, the method can return to operation 910 to interpolate the R matrix from the calculated current temperature.

Again at operation 910, the processing device of the system determines an R matrix 802 associated with the current temperature of the surface 102 based on an interpolation of the several pre-extracted R matrices. The operation can correspond to operation 408 of the method shown in FIG. 4. The R matrix 802 is interpolated from the calculated top block surface temperature value (averaged).

Interpolation of the R matrix 802 can follow from interpolation of the HTC. More particularly, the processing device of the system can determine an interpolated HTC, and the R matrix 802 can follow from the interpolated HTC. In an embodiment, the following equation can be used, based on the current temperature (which is different than the initial temperature) to determine an interpolated HTC.

$$H T C i = H T C 1 + [ \frac{T i - T 1}{T 2 - T 1} ] * ( H T C 2 - H T C 1 ) ,$$

where:
HTCi: Interpolated HTC value based on current temperature.
HTC1: Starting HTC, e.g., 10 W/m². K. May be the nearest pre-defined HTC value, where HTC1<HTCi.
HTC2: Bounding HTC from the lookup table, e.g., 30 W/m². K. May be the nearest pre-defined HTC value, where HTC2>HTCi.
Ti: Current temperature calculated as the average temperature of all top surface areas (all cells on the top surface).
T1: Starting temperature, e.g., 20° C.
T2: Bounding temperature, e.g., 60° C.

The interpolated HTC, HTCi, can be calculated according to the above equation. The HTC value may be calculated on an individual cell basis, but rather, can be an average HTC for the entire top surface area corresponding to the current temperature. It will be appreciated that HTCi is interpolated from the HTC lookup table 504 values, based on the current temperature 506. Accordingly, the method can interpolate the HTC 502 using a predefined temperature 506 versus HTC lookup table 504.

Still referring to operation 910, the R matrix 802 can be determined based on the interpolated HTC. More particularly, the interpolation of the R matrix 802 can be performed using an equation that linearly interpolates based on reciprocal HTC values. In an embodiment, the following equation can be used, based on the interpolated HTC to determine an interpolated R matrix 802.

$$R i = R 1 + [ \frac{1 / H T C i - 1 / H T C 1}{1 / H T C 2 - 1 / H T C 1} ] * ( R 2 - R 1 ) ,$$

where:
Ri: Interpolated R matrix 802 based on the interpolated HTC, HTCi.
R1: Starting R matrix used for initial thermal evaluation. May be the pre-extracted R matrix corresponding to HTC1.
R2: Bounding R matrix corresponding to the bounding HTC, HTC2.
HTCi, HTC1, and HTC2: See above.

Notably, the R matrix 802 can be interpolated on a cell-by-cell basis. For example, the R matrix elements may be updated according to the equation above, individually. Accordingly, Ri may refer to a particular element of the R matrix 802, e.g., Rmn, in the R matrices shown in FIG. 8, and the R1 and R2 value may refer to the Rmn value of R matrices 802a and 802b, respectively.

Using the interpolated R matrix 802, at operation 912, the R matrix evaluation may be run. More particularly, the processing device of the system can perform thermal evaluation for the physical object 100 based on the interpolated R matrix 802 to obtain an updated temperature of the surface 102. The operation can correspond to operation 410 of the method shown in FIG. 4. Each of the several R matrices received at operation 902 and indeed the interpolated R matrix 802 determined at operation 910 includes thermal resistance values 804 representing a relationship between the power sources 702 of the physical object 100 and several temperature rises at corresponding locations on the surface 102 of the physical object 100. The complete thermal evaluation is executed by applying the interpolated R matrix 802 to the current power matrix. Accordingly, the method includes determining the several temperature rises at the corresponding locations on the surface 102 based on the power matrix representing power values applied to the several power sources 702. The interpolated R matrix 802 is multiplied by the power matrix—using vector-matrix operations—to yield a preliminary temperature vector for all monitored die tiles. The resulting temperature field provides spatially resolved temperature predictions for each of the targeted logic dies, DRAM, and the top surface area.

The process can repeat operation 914 to compute an updated temperature, which is a new averaged target-surface temperature, directly from the temperature field obtained in operation 912. The updated temperature can be used in a convergence check.

Again returning to operation 916, the convergence check is performed. More particularly, the system determines whether the convergence criteria is met. The determination can check whether the convergence criteria is met based on a comparison of the current temperature and the updated temperature to determine whether convergence has been reached. An absolute difference between the updated temperature and the current temperature from the immediately preceding iteration can be calculated. The comparison can include determining whether the difference between the updated temperature and the current temperature is less than the predetermined temperature threshold established in operation 904. If the temperature difference is greater than the convergence tolerance threshold, e.g., a small, predefined threshold value such as 0.5° C., and the iteration counter has not reached the maximum, the process deems the solution unconverged. In that case, i.e., in response to the difference being greater than the predetermined temperature threshold, the process can cycle back to operation 910 and a second R matrix 802 can be interpolated based on the several R matrices. For example, the second R matrix 802 can be interpolated relative to the interpolated R matrix 802. The algorithm increments the iteration counter, sets the HTC for the next iteration to the newly interpolated value, and constructs a correspondingly interpolated second R matrix 802. Conversely, if the temperature difference is within tolerance then the algorithm exits the loop. The process may also end in response to the maximum iteration count being reached. For example, in response to the maximum iteration count being reached by operations 910-914 being repeated through iteration by the predefined count limit, the system can determine that convergence is reached and can end the iterative process.

At operation 918, the system can determine, in response to the convergence criteria being met, a temperature distribution at the surface 102 of the physical object 100 based on the interpolated R matrix 802. The operation can correspond to operation 412 of the method shown in FIG. 4. Upon satisfaction of the convergence criteria, the processing device finalizes the evaluation by exporting the converged temperature field data to persistent storage or to downstream design-automation tools. The exported dataset typically includes per-tile die temperatures, component-level temperature statistics, and the final averaged surface temperature, enabling designers to perform thermal-aware floor planning, sensor-placement optimization, or reliability analysis. Once export is complete, the procedure releases allocated resources and terminates, leaving the system ready for a subsequent thermal-evaluation request.

Referring to FIG. 10, a schematic view of a physical object having several power sources is shown in accordance with an embodiment. The temperature distribution can be determined for a particular floor plan of the physical object 100. For example, a first layout of the AP package 108 is shown having one or more power sources 702 in predetermined locations. The first layout can be provided as an input file that includes the locations of the components within a plane, e.g., an X-Y plane. By way of example, the file can be a CSV file representing coordinates (0, 0) to (8, 8) in the X-Y plane, and the sources may be indicated by respective coordinates, e.g., the power source PD1 may have bounding coordinates (1, 1) to (2, 2).

Referring to FIG. 11, a pictorial view of a temperature distribution of a surface of a physical object is shown in accordance with an embodiment. The temperature distribution determined at operation 918 is shown and include surface temperatures 1102 that correspond to the underlying power sources 702. The temperature distribution across various surfaces, e.g., the top surface 102 and one or more additional surfaces, of the physical object 100 can be determined based on the final interpolated R matrix 802, as described above. The temperature distribution shows elevated temperatures, indicated by color changes in the displayed representation, at the locations corresponding to the underlying power sources 702.

Referring to FIG. 12, a schematic view of a physical object having several power sources is shown in accordance with an embodiment. Additional cases may be analyzed. The additional cases can include system components, e.g., power sources 702, located at different positions of the floor plan. The different floor plan design can have power sources 702 that generate heat at different locations and therefore produce an alternative temperature distribution on the top surface 102.

Referring to FIG. 13, a pictorial view of a temperature distribution of a surface of a physical object is shown in accordance with an embodiment. The temperature distribution on the top surface 102 can be determined using the methods described above. The final converged results can provide the R matrix 802 that is used to determine the temperature distribution. As shown, the temperature distribution can vary from the baseline floor plan of FIG. 10. A user can continue to evaluate different designs in the manner of FIGS. 10-13 to arrive at a final floor plan design for manufacturing.

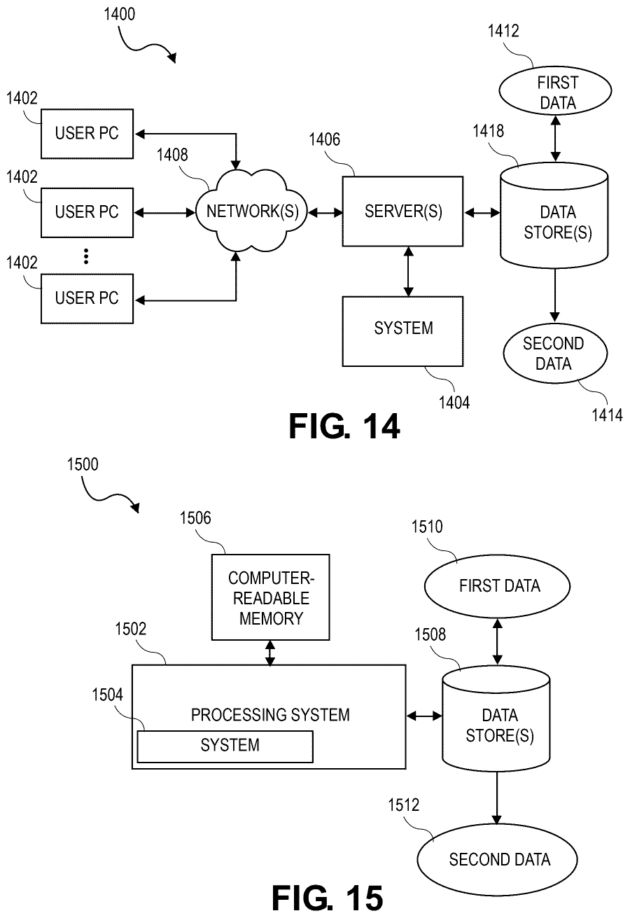

The methods and systems described herein may be implemented using any suitable processing system with any suitable combination of hardware, software, and/or firmware, such as described below with reference to the non-limiting examples of FIGS. 14-16. The suitable system can include a memory and a processing device. For example, the memory can include a non-transitory computer-readable medium storing instructions executable by the processing device of the system to cause the system to perform any of the operations of the method described above. Accordingly, the suitable system can perform a computer-implemented method.

Referring to FIG. 14, a system that may be used in conjunction with the embodiments described herein is shown. FIG. 14 depicts at 1400 a computer-implemented environment wherein users 1402 can interact with a system 1404 hosted on one or more servers 1406 through a network 1408. The system 1404 contains software operations or routines. The users 1402 can interact with the system 1404 through a number of ways, such as over one or more networks 1408. One or more servers 1406 accessible through the network(s) 1408 can host system 1404. The servers 1406 can have access to memory, e.g., data stores 1410. The one or more data stores 1410 may contain first data 1412 as well as second data 1414. It should be understood that the system 1404 could also be provided on a stand-alone computer for access by a user.

Referring to FIG. 15, a system that may be used in conjunction with the embodiments described herein is shown. FIG. 15 depicts an exemplary system 1500 that includes a standalone computer architecture where a processing system 1502 (e.g., one or more computer processors) includes a system 1504 being executed on it. The processing system 1502 has access to memory, e.g., a non-transitory computer-readable memory 1506 in addition to one or more data stores 1508. The one or more data stores 1508 may contain first data 1510 as well as second data 1512.

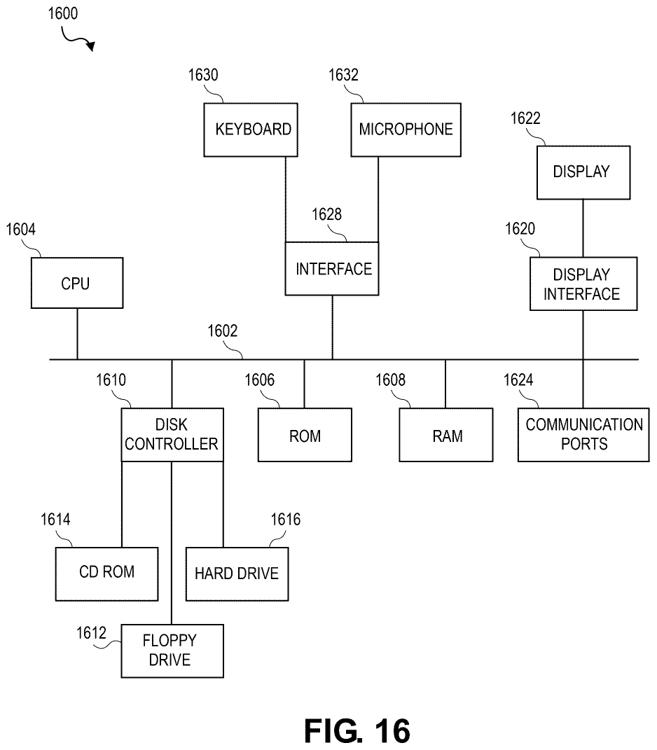

Referring to FIG. 16, a system that may be used in conjunction with the embodiments described herein is shown. FIG. 16 shows a block diagram of exemplary hardware for a standalone computer architecture 1600, such as the architecture depicted in FIG. 16, that may be used to contain and/or implement the program instructions of system embodiments of the present invention. A bus 1602 may serve as the information highway interconnecting the other illustrated components of the hardware. A processing system 1604 labeled CPU (central processing unit) (e.g., one or more computer processors), may perform calculations and logic operations required to execute a program. A non-transitory computer-readable storage medium, such as read only memory (ROM) 1606 and random access memory (RAM) 1608, may be in communication with the processing system 1604 and may contain one or more programming instructions. Optionally, program instructions may be stored on a non-transitory computer-readable storage medium such as a magnetic disk, optical disk, recordable memory device, flash memory, or other physical storage medium. Computer instructions may also be communicated via a communications signal, or a modulated carrier wave, e.g., such that the instructions may then be stored on a non-transitory computer-readable storage medium.

A disk controller 1610 interfaces one or more optional disk drives to the system bus 1602. These disk drives may be external or internal floppy disk drives such as 1612, external or internal CD-ROM, CD-R, CD-RW, or DVD drives such as 1614, or external or internal hard drives 1616. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 1610, the ROM 1614 and/or the RAM 1608. Preferably, the processing device 1604 may access each component as required.

A display interface 1620 may permit information from the bus 1602 to be displayed on a display 1622 in audio, graphic, or alphanumeric format. Communication with external devices may optionally occur using various communication ports 1624.

In addition to the standard computer-type components, the hardware may also include data input devices. The data input devices can transfer information to the bus 1602 through an interface 1628. The data input device can include a keyboard 1630, or other input device, such as a microphone 1632, remote control, pointer, mouse, touchscreen, and/or joystick.

This written description describes exemplary embodiments of the invention, but other variations fall within scope of the disclosure. For example, the systems and methods may include and utilize data signals conveyed via networks (e.g., local area network, wide area network, internet, combinations thereof, etc.), fiber optic medium, carrier waves, wireless networks, etc. for communication with one or more data processing devices. The data signals can carry any or all of the data disclosed herein that is provided to or from a device.

The methods and systems described herein may be implemented on many different types of processing devices by program code comprising program instructions that are executable by the device processing system. The software program instructions may include source code, object code, machine code, or any other stored data that is operable to cause a processing system to perform the methods and operations described herein. Any suitable computer languages may be used such as C, C++, Java, etc., as will be appreciated by those skilled in the art. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other non-transitory computer-readable media for use by a computer program.

The computer components, software modules, functions, data stores and data structures described herein may be connected directly or indirectly to each other in order to allow the flow of data needed for their operations. It is also noted that a module or processing device includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

The preceding detailed descriptions are presented in terms of algorithms and symbolic representations of operations on data bits within a device memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “sending,” “terminating,” “waiting,” “changing,” or the like, refer to the action and processes of a device, or similar electronic computing device, that manipulates and transforms data represented as physical (electronic) quantities within registers and memories of the device into other data similarly represented as physical quantities within the device memories or registers or other such information storage, transmission or display devices.

The processes and displays presented herein are not inherently related to any particular device or other apparatus. Various general-purpose systems may be used with programs in accordance with the teachings herein, or it may prove convenient to construct a more specialized apparatus to perform the operations described. The required structure for a variety of these systems will be evident from the description below. In addition, the disclosure is not described with reference to any particular programming language. It will be appreciated that a variety of programming languages may be used to implement the teachings of the disclosure as described herein.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method, comprising:
receiving, by a memory of a system, a plurality of heat transfer coefficients (HTCs) respectively associated with a plurality of temperatures corresponding to a surface of a physical object, and a plurality of thermal resistance (R) matrices associated with respective HTCs of the plurality of HTCs;
determining, by a processing device of the system, an R matrix associated with a current temperature of the surface based on an interpolation of the plurality of R matrices, wherein the current temperature is based on a power distribution applied to a plurality of power sources of the physical object;
performing, by the processing device of the system, thermal evaluation for the physical object based on the R matrix to obtain an updated temperature of the surface; and
determining, in response to a convergence criteria being met, a temperature distribution at the surface of the physical object based on the R matrix.

2. The computer-implemented method of claim 1, wherein each of the plurality of R matrices includes a thermal resistance value representing a relationship between the plurality of power sources of the physical object and a plurality of temperature rises at corresponding locations on the surface of the physical object.

3. The computer-implemented method of claim 2 further comprising determining the plurality of temperature rises at the corresponding locations on the surface based on a power matrix representing power values applied to the plurality of power sources.

4. The computer-implemented method of claim 1 further comprising determining an interpolated HTC based on the current temperature of the surface, and determining the R matrix based on the interpolated HTC.

5. The computer-implemented method of claim 4, wherein the interpolated HTC is interpolated from an HTC lookup table based on the current temperature of the surface.

6. The computer-implemented method of claim 1 further comprising determining whether the convergence criteria is met based on a comparison of the current temperature and the updated temperature.

7. The computer-implemented method of claim 6, wherein the comparison includes determining whether a difference between the updated temperature and the current temperature is less than a predetermined temperature threshold.

8. The computer-implemented method of claim 7 further comprising determining, in response to the difference being greater than the predetermined temperature threshold, a second R matrix interpolated based on the plurality of R matrices.

9. A non-transitory computer-readable medium storing instructions executable by a processing device of a system to cause the system to:
receive a plurality of heat transfer coefficients (HTCs) respectively associated with a plurality of temperatures corresponding to a surface of a physical object, and a plurality of thermal resistance (R) matrices associated with respective HTCs of the plurality of HTCs;
determine an R matrix associated with a current temperature of the surface based on an interpolation of the plurality of R matrices, wherein the current temperature is based on a power distribution applied to a plurality of power sources of the physical object;
perform thermal evaluation for the physical object based on the R matrix to obtain an updated temperature of the surface; and
determine, in response to a convergence criteria being met, a temperature distribution at the surface of the physical object based on the R matrix.

10. The non-transitory computer-readable medium of claim 9, wherein each of the plurality of R matrices includes a thermal resistance value representing a relationship between the plurality of power sources of the physical object and a plurality of temperature rises at corresponding locations on the surface of the physical object.

11. The non-transitory computer-readable medium of claim 10, wherein the instructions further cause the system to determine the plurality of temperature rises at the corresponding locations on the surface based on a power matrix representing power values applied to the plurality of power sources.

12. The non-transitory computer-readable medium of claim 9, wherein the instructions further cause the system to determine an interpolated HTC based on the current temperature of the surface, and determining the R matrix based on the interpolated HTC.

13. The non-transitory computer-readable medium of claim 12, wherein the interpolated HTC is interpolated from an HTC lookup table based on the current temperature of the surface.

14. The non-transitory computer-readable medium of claim 9, wherein the instructions further cause the system to determine whether the convergence criteria is met based on a comparison of the current temperature and the updated temperature.

15. A system, comprising:
a memory to store a plurality of heat transfer coefficients (HTCs) respectively associated with a plurality of temperatures corresponding to a surface of a physical object, and a plurality of thermal resistance (R) matrices associated with respective HTCs of the plurality of HTCs; and
a processing device to:
determine an R matrix associated with a current temperature of the surface based on an interpolation of the plurality of R matrices, wherein the current temperature is based on a power distribution applied to a plurality of power sources of the physical object,
perform thermal evaluation for the physical object based on the R matrix to obtain an updated temperature of the surface, and
determine, in response to a convergence criteria being met, a temperature distribution at the surface of the physical object based on the R matrix.

16. The system of claim 15, wherein each of the plurality of R matrices includes a thermal resistance value representing a relationship between the plurality of power sources of the physical object and a plurality of temperature rises at corresponding locations on the surface of the physical object.

17. The system of claim 16, wherein the processing device is further to determine the plurality of temperature rises at the corresponding locations on the surface based on a power matrix representing power values applied to the plurality of power sources.

18. The system of claim 15, wherein the processing device is further to determine an interpolated HTC based on the current temperature of the surface, and determining the R matrix based on the interpolated HTC.

19. The system of claim 18, wherein the interpolated HTC is interpolated from an HTC lookup table based on the current temperature of the surface.

20. The system of claim 15, wherein the processing device is further to determine whether the convergence criteria is met based on a comparison of the current temperature and the updated temperature.
